(19) United States
(12) Patent Application Publication
(10) Pub. No.: US 2016/0248337 A1
(43) Pub. Date: Aug. 25, 2016

(54) Power Conversion Apparatus

(71) Applicant: Hitachi, Ltd., Tokyo (JP)

(72) Inventor: Shinji SHIRAKAWA, Tokyo (JP)

(21) Appl. No.: 15/015,384

(22) Filed: Feb. 4, 2016

(30) Foreign Application Priority Data
Feb. 24, 2015 (JP) 2015-033492

(51) Int. Cl. H02M 7/00

(52) U.S. Cl. CPC H02M 7/003

(57) ABSTRACT

A power conversion apparatus that is configured by a plurality of conversion circuit modules which are connected to each other in parallel, includes a first wiring that connects a positive electrode terminal of a first conversion circuit module among the conversion circuit modules, and a positive electrode side of a direct current wiring which supplies a direct current to the first conversion circuit module, and a second wiring that connects a negative electrode terminal of a second conversion circuit module which is different from the first conversion circuit module among the conversion circuit modules, and a negative electrode side of a direct current wiring which supplies a direct current to the second conversion circuit module, in which when a direct current flows to the power conversion apparatus, the first wiring and the second wiring are arranged such that a magnetic coupling is generated between the first wiring and the second wiring.

### BACKGROUND OF THE INVENTION

1. Field of the Invention

The present invention relates to a power conversion apparatus.

2. Background Art

In recent years, there have been movements not only to achieve capacity enlargement of a conversion circuit module configuring a power conversion apparatus along with the capacity enlargement of the power conversion apparatus, but also to respond to the capacity enlargement by using a plurality of conversion circuit modules in parallel.

FIG. 9 is a circuit diagram illustrating a con figuration of a power conversion apparatus using the plurality of conversion circuit modules.

In the example, the power conversion apparatus uses the conversion circuit modules by three, and is configured by a forward conversion apparatus, and a backward conversion apparatus. The conversion circuit modules 21 to 23 function as a backward conversion apparatus that converts a direct current voltage into an alternating current voltage, and the conversion circuit modules 24 to 26 function as a forward conversion apparatus that converts the alternating current voltage into the direct current voltage. The conversion circuit modules 1a to 1f are connected to a negative electrode side direct current wiring 19, and a positive electrode side direct current wiring 20. That is, a negative electrode terminal and the negative electrode side direct current wiring of each conversion circuit module are electrically connected to each other through fuses 18a, 18c, 18e, 18g, 18i, and 18k, and a positive electrode terminal and the positive electrode side direct current wiring are electrically connected to each other through fuses 18b, 18d, 18f, 18h, 18j, and 18l. The conversion circuit module 1a is a U phase of the backward conversion apparatus, the conversion circuit module 1b is a V phase of the backward conversion apparatus, the conversion circuit module 1c is a W phase of the backward conversion apparatus, the conversion circuit module 1d is an R phase of the forward, conversion apparatus, the conversion circuit module 1e is an S phase of the forward conversion apparatus, and the conversion circuit module 1f is a T phase of the forward conversion apparatus. Furthermore, terminals 21 to 26 are output terminals of the conversion circuit modules 1a to 1f.

When the power conversion apparatus is configured by connecting the plurality of conversion circuit modules to each other in parallel, in order to enlarge the capacity, it is possible to increase the number of parallel conversion circuit modules up to the necessary capacity, and it is possible to realize a circuit which summarizes the output terminals of each of the conversion circuit modules, as a power conversion apparatus of one phase.

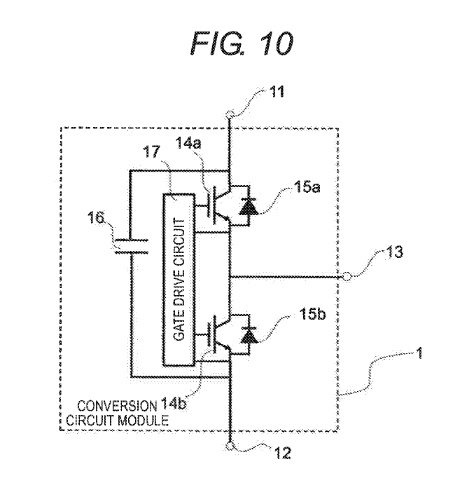

Here, the configuration of the conversion circuit module will be briefly described by using FIG. 10.

FIG. 10 is a circuit diagram illustrating a configuration of the conversion circuit module.

A conversion circuit module 1 is a half bridge circuit that is configured by IGBT 14a and IGBT 14b which are semiconductor switches, diodes 15a and 15b, a positive electrode terminal 11, a negative electrode terminal 12, and an output terminal 13. Furthermore, the conversion circuit module 1 is configured by a wiring that connects a capacitor 16 which is connected between the direct current wirings, and connects a gate drive circuit 17 which turns on or turns off IGBT 14a and IGBT 14b to the components. The gate drive circuit is controlled by a high order control apparatus, but a signal wiring and a power supply wiring from the high order control apparatus will be omitted in FIG. 10. Moreover, in the conversion circuit module of FIG. 10, IGBT and the diode may increase the number of parallel elements, depending on an output capacity of one conversion circuit module. Furthermore, as the current of the semiconductor switch within the conversion circuit module is balanced, a structure of the conversion circuit module is not discussed in the present invention.

As described above, in the capacity enlargement of the power conversion apparatus, it is possible to connect the conversion circuit modules 1 to each other in parallel by the necessary number, and it is possible to make the circuit which summarizes the output terminal of the half bridge circuit into the power conversion apparatus. However, when the conversion circuit module 1 is parallelized, if a difference is generated in the size of impedance of the wiring connecting the semiconductor switches, or a difference is generated in a waveform of a gate signal for driving the semiconductor switch, the current flowing through the semiconductor switch in synchronization with ON-OFF is in non-equilibrium. If the current non-equilibrium becomes large, element destruction may result, by making the excessive current flow through a portion of the semiconductor switch.

In the related art, when there is the large current non-equilibrium, a current value of the element which the largest current flows through is lowered up to a value that is capable of being safely operated. In this case, in order to secure the capacity of the power conversion apparatus, design is performed such, that the number of parallel conversion circuit modules is increased, and a cost increase or an increase in a space of the apparatus becomes a problem.

As a technology of solving the current non-equilibrium, JP-A-2010-193582 discloses that reactances are connected to output terminals of a plurality of conversion circuit modules. In the technology, by a magnetic coupling on the output terminal side, the electromotive force is generated in a direction of reducing the current difference, and the current is uniformized in the output terminal of each conversion circuit module.

However, in JP-A-2010-193582, for example, when the low frequency current such as 50 Hz is used, if the reactance is designed in accordance with the frequency of the output current, a reactance component becomes large, and it leads to the increase in size of the power conversion apparatus.

### SUMMARY OF THE INVENTION

An object of the present invention is to reduce current non-equilibrium of each conversion circuit module, in a power conversion apparatus where a plurality of conversion circuit, modules are connected, to each other in parallel.

According to an aspect of the present invention, there is provided a power conversion apparatus that is configured by a plurality of conversion circuit modules which are connected to each other in parallel, including a first wiring that connects a positive electrode terminal of a first conversion circuit module among the conversion circuit modules, and a positive electrode side of a direct current wiring which supplies a direct current to the first conversion circuit, module, and a second wiring that connects a negative electrode terminal of a second conversion circuit module which is different from the first conversion circuit module among the conversion circuit modules, and a negative electrode side of a direct current wiring which supplies a direct current to the second conversion circuit module, in which when a direct current flows to the power conversion apparatus, the first wiring and the second wiring are arranged such that a magnetic coupling is generated between the first wiring and the second wiring.

According to the present invention, it is possible reduce current non-equilibrium of each conversion circuit module, in the power conversion apparatus where the plurality of conversion circuit modules are connected to each other in parallel.

BRIEF DESCRIPTION OF THE DRAWINGS

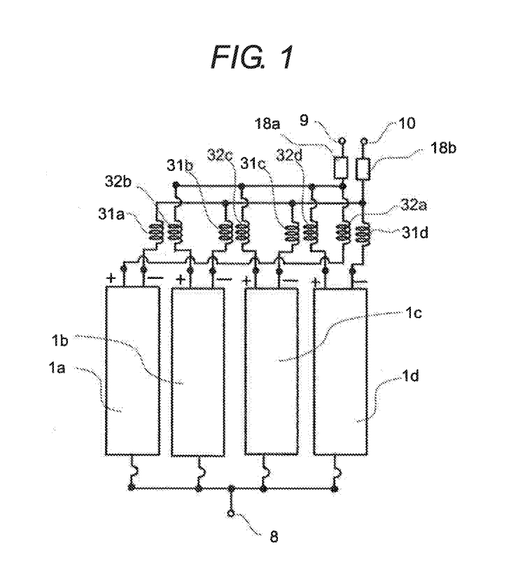

FIG. 1 is a circuit diagram illustrating a wiring structure of a plurality of conversion circuit modules in the present example.

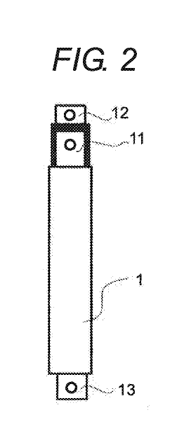

FIG. 2 is a view illustrating a shape of the conversion circuit module.

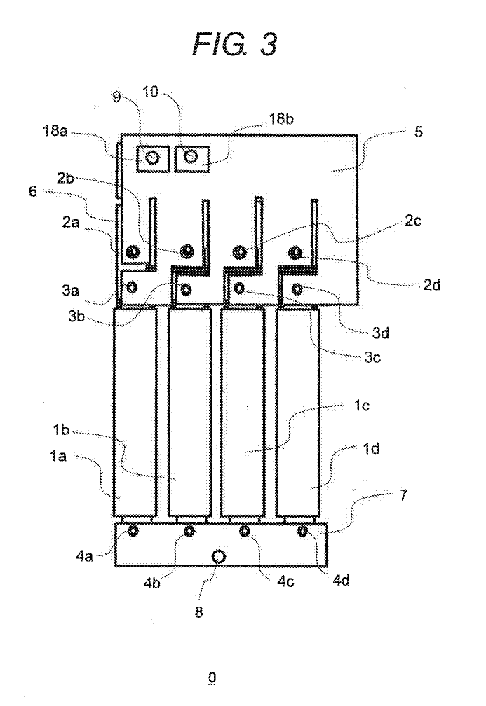

FIG. 3 is a view illustrating a power conversion apparatus that is configured by connecting the plurality of conversion circuit modules to each other in parallel, in the present example.

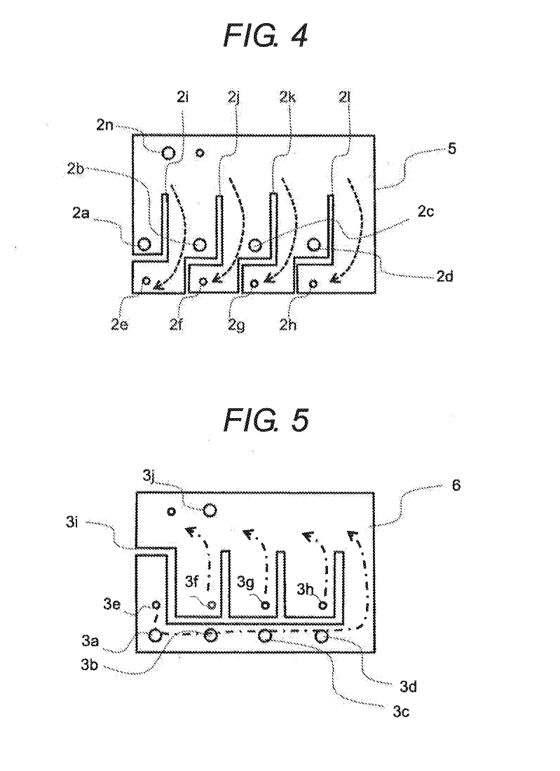

FIG. 4 is a view illustrating a structure of a conductive plate in the present example.

FIG. 5 is a view illustrating a structure of another conductive plate in the present example.

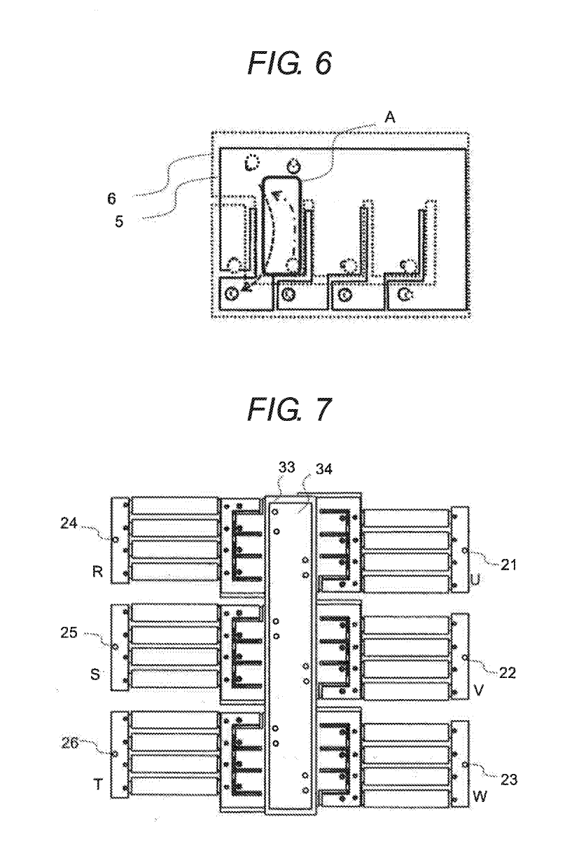

FIG. 6 is a view of a case where the conductive plate and another conductive plate are assembled so as to overlap each other as FIG. 3, in the present example.

FIG. 7 is a configuration view of a power conversion apparatus using a first embodiment, of the present invention.

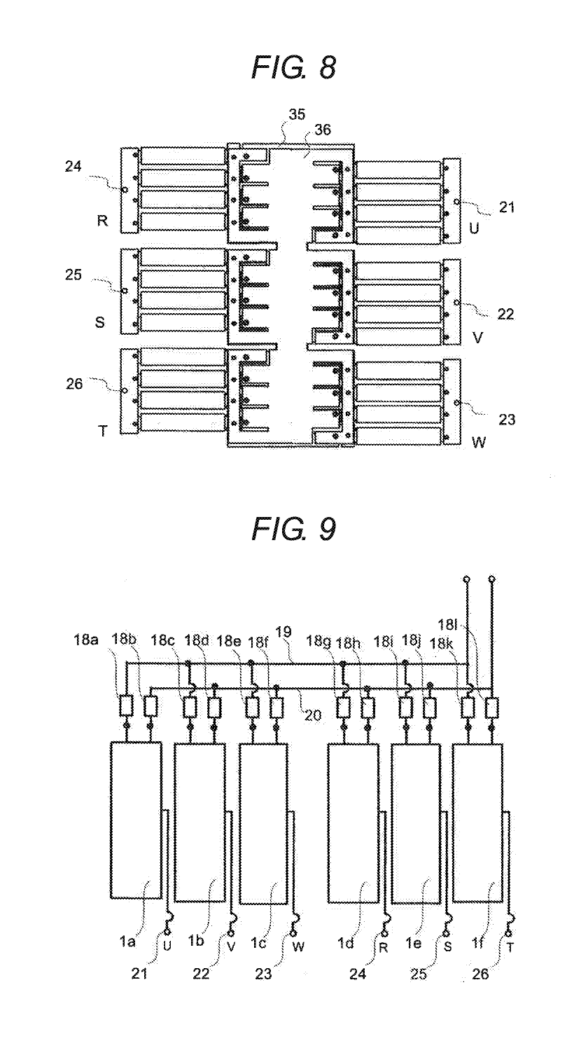

FIG. 8 is a configuration view of the power conversion apparatus using the first embodiment of the present invention of a product for which a fuse is unnecessary.

FIG. 9 is a circuit diagram illustrating a configuration of a power conversion apparatus using the plurality of conversion circuit modules.

FIG. 10 is a circuit diagram illustrating a configuration of the conversion circuit module.

### DETAILED DESCRIPTION OF THE INVENTION

Hereinafter, embodiments will be described by using the drawings.

### EXAMPLE 1

FIG. 1 is a circuit diagram illustrating a wiring structure of a plurality of conversion circuit modules in the present example.

As illustrated in FIG. 1, in a direct current wiring where a plurality of conversion circuit modules 1a to 1d are connected to each other in parallel, a point in which a wiring that connects a positive electrode terminal of a conversion circuit module and a positive electrode 9, and a wiring that connects a negative electrode terminal of a conversion circuit module which is different from the above conversion circuit module and a negative electrode 10, face each other and are closely arranged so as to make a magnetic coupling, becomes a feature. For example, a wiring 31a that is connected between the positive electrode terminal and the positive electrode 9 of the conversion circuit module 1a, and a wiring 32b that is connected between the negative electrode terminal and the negative electrode 10 of the conversion circuit module 1b, are wired so as to be adjacent to each other.

Here, the magnetic coupling is a phenomenon that is generated in accordance with the law of electromagnetic induction of Faraday, and is a phenomenon in which if a current flowing through one wiring is time-changed, the current flows to a conductor which is in the vicinity of the wiring, such that a change of a magnetic field which is generated by the current flowing through the wiring becomes small. In the example of FIG. 1, if the current flows toward the conversion circuit module 1b from the positive electrode 9 in the wiring 32b, the magnetic field is generated around the wiring 32b. At that time, the current flows through the wiring 31a such that the change of the magnetic field becomes small. That is, the electromotive force that makes the current of the same size as a value of the current flowing through the wiring 32b flow toward the negative electrode 10 from the conversion circuit module 1a, is generated. The present example uses the law, and is a method for balancing a current flowing to a semiconductor switch in a self-consistent manner, by the current flowing through the wiring that is connected to the positive electrode terminal of each conversion circuit module at the time of switching, and the current flowing through one wiring that is connected to the negative electrode terminal of the conversion circuit module which is different from the above conversion circuit module. That is, between a direct current circuit and the conversion circuit module, a configuration in which a wiring that connects the positive electrode terminal of one conversion circuit module among the plurality of conversion circuit modules and the positive electrode side of the direct current wiring, and a wiring that connects the negative electrode terminal of the above one conversion circuit module and the negative electrode side of the direct, current wiring, face each other and are closely arranged so as to make the magnetic coupling, is included. By the magnetic coupling, it is possible to generate the electromotive force in the direction of reducing the current, difference at the time of the switching of the conversion circuit module. By adopting the configuration, since the configuration is the method for balancing the high frequency current flowing through, the direct current wiring at the time of the switching, a large inductance is not necessary, in comparison with a case where a reactance is arranged on the output side. In FIG. 1, the magnetic coupling is generated by the wiring of the conversion circuit modules which are adjacent to each other, but there is no need that the modules are adjacent to each other, and the magnetic coupling is generated by the wiring of the module which is different from, the self-module, and thereby, it is possible to achieve the effects of the present invention.

Here, a structure of the conversion circuit module will be briefly described by using FIG. 2.

FIG. 2 is a view illustrating a shape of the conversion circuit module. As illustrated in FIG. 2, a positive electrode terminal 11 and a negative electrode terminal 12 are arranged on one end side of a main body of the conversion circuit module, and an output terminal 13 is arranged on the other end side. The positive electrode terminal 11 and the negative electrode terminal 12 are connected to through holes 3a to 3d, and through holes 2a to 2d in FIG. 3.

As a shape of the wiring for making the magnetic coupling, it is possible to configure the wiring by a plurality of conductive plates, in addition to the case where the wiring is configured by a coil as illustrated in FIG. 1. Hereinafter, the case where the conductive plate is used, will be described.

FIG. 3 is a view illustrating a power conversion apparatus that is configured by connecting; the plurality of conversion circuit modules to each other in parallel in the present example.

In an apparatus 0, one phase of the power conversion apparatus is configured by connecting four of the conversion circuit modules 1a, 1b, 1c, and 1d to each other in parallel. The positive electrode terminals of the respective conversion circuit modules 1a, 1b, 1c, and 1d are connected to the through holes 2a, 2b, 2c, and 2d which are arranged in a conductive plate 5, through a screw or the like which is not illustrated in the drawing. Similarly, the negative electrode terminals of the respective conversion circuit modules 1a, 1b, 1c, and 1d are connected to the through holes 3a, 3b, 3c, and 3d which are arranged in a conductive plate 6, through the screw or the like which is not illustrated in the drawing. The conductive plate 5 and the conductive plate 6 are respectively connected to the positive electrode 9 side and the negative electrode 10 side of the direct current wiring.

Hereinafter, structures of the conductive plate 5 and the conductive plate 6 will be described while using FIG. 4 and FIG. 5.

FIG. 4 is a view illustrating the structure of the conductive plate 5 in the present example.

In the conductive plate 5, the through holes 2a, 2b, 2c, and 2d for being connected to the positive electrode terminals of the respective conversion circuit modules, are arranged, and holes 2e, 2f, 2g, and 2h for assembling the conductive plate 6 described later, are included. Moreover, a hole 2n for being connected, to the positive electrode, is also arranged. Therefore, in the conductive plate 5, slits 2h, 2i, 2j, and 2k are arranged. By the slits, the current, circuit, is formed, such that the current flows to the through holes 2a, 2b, 2c, and 2d from the positive electrode. The flow of the current is schematically illustrated by a dashed line arrow.

FIG. 5 is a view illustrating the structure of the conductive plate 6 in the present example.

In the conductive plate 6, through holes 3e, 3f, 3g, and 3h for being connected to the negative electrode terminals of the respective conversion circuit modules, are arranged, and the holes 3a, 3b, 3c, and 3d for assembling the conductive plate 5, are included. Moreover, a hole 3j for being connected to the negative electrode, is also arranged. Therefore, in the conductive plate 6, a slit 3i is arranged. By the slit, the current circuit is formed such that the current flows to the negative electrode from the through holes 3e, 3f, 3g, and 3h. The flow of the current is schematically illustrated by a one dot dashed line arrow.

FIG. 6 is a view of the case where the conductive plate 5 and the conductive plate 6 are assembled so as to overlap each other as FIG. 3, in the present example. For the description, the conductive plate 5 and the conductive plate 6 are described by slightly being shifted, but are actually assembled such that the through holes and the holes are overlapped each other. Moreover, an insulating plate is interposed between the conductive plate 5 and the conductive plate 6, and thereby, the electrical insulation is taken, but the description of the insulating plate is omitted.

As illustrated in FIG. 6, since a region A where current flow paths which are formed in the respective conductive plates are overlapped each other, is formed, the magnetic coupling is possible by the flow of the current which flows through the conductive plate 5, and is illustrated by the dashed line arrow, and the flow of the current which flows through the conductive plate 6, and is illustrated by the one clot dashed line arrow, in the region A. Accordingly, by the magnetic coupling in the region A, it is possible to generate the electromotive force in the direction of reducing the current difference, and in the conversion circuit modules 1a and 1b, it is possible to balance the current flowing to the semiconductor switch in the self-consistent manner. Other conversion circuit modules are in the same manner. As a result, in a power conversion circuit on which the conductive plate 5 of FIG. 4 and the conductive plate 6 of FIG. 5 are mounted by the configuration illustrated in FIG. 3, when there is the difference in the current flowing through the wiring that is connected to the positive electrode terminal of each conversion circuit, module, and the wiring that is connected to the negative electrode terminal of the conversion circuit module which is different from the above conversion circuit module where the magnetic coupling is strongly made, by the magnetic coupling, the electromotive force is generated in the direction where the same amount of the current flows, and the current difference becomes small in the self-consistent manner. Therefore, it is possible to reduce the current non-equilibrium of the semiconductor switch in synchronization with the switching, and there is the effect of performing the utilization up to the value which is close to a performance limit of a semiconductor device without lowering the current value of the semiconductor switch.

If the wiring using the conductive plate is configured as described above, particularly, in the parallelization of the conversion circuit modules of three or more, the conductive plates which are connected to each other in parallel, and the shape of strengthening the magnetic coupling of the conductive plate which is connected to the positive electrode terminal or the negative electrode terminal of the self-conversion circuit module, and the conductive plate that is connected to the negative electrode terminal or the positive electrode terminal, of the conversion circuit module which is adjacent thereto, are determined in accordance with the same rule, and thereby, it is possible to achieve the effects of the present invention with a simple configuration.

In the structure such as the conductive plate 5 and the conductive plate 6 where the slits illustrated in FIG. 4 and FIG. 5 are formed, depending on a forming manner of the slit, a portion overlapping each other is made in the current flow path that is connected to the positive electrode terminal or the negative electrode terminal of the self-conversion circuit module. Accordingly, it is preferable that the current flow path which uses the terminal of the conversion circuit module as a starting point, and the current flow path of strengthening the magnetic coupling are made to be the same in shape. Thereby, it is possible to suitably generate the magnetic coupling by the desired conversion circuit modules. Alternatively, even though the portion overlapping each other is made, an area where the current circuits of the desired conversion circuit modules are overlapped each other is made to be larger than the portion overlapping each other, and thereby, it is possible to generate the suitable magnetic coupling.

Furthermore, since being the phenomenon by generating the difference in current time-change at the time of the switching, the difference in the characteristics of a plurality of semiconductor devices which are switched in synchronization with each other, becomes a cause of the current difference, but does not disturb the effects of the present invention.

Moreover, in the above description, the current flow path is formed by arranging the slit in the conductive plate, but the current flow path may be arranged by arranging an insulating material in the conductive plate, in addition to the case where the slit is arranged.

### EXAMPLE 2

FIG. 7 is a configuration view of a power conversion apparatus using a first embodiment of the present invention.

FIG. 7 illustrates an embodiment in which a power conversion circuit of one phase is used by parallelizing four conversion circuit modules of FIG. 1. In FIG. 8, the output terminals of four conversion circuit modules that are connected to each other in parallel, are connected to a U phase output terminal 21, a V phase output terminal 22, and a W phase output terminal 23 of a backward converter, and an R phase output terminal 21, an S phase output terminal 22, and a T phase output terminal 23 of a forward converter. In FIG. 7, the output terminals of four conversion circuit modules are connected to the conversion circuits of other phases through the fuses 18a and 18b of FIG. 1. For example, in a case of a three-phase alternating current, output, since the current which flows in from the U phase, flows out from the V phase and the W phase, it is preferable that the impedance between the phases becomes low in order to reduce the loss or the potential fluctuation. Therefore, a configuration in which conductive plates 33 and 34 that are connected between the phases are widely stacked, is made. By the configuration, at the time of increasing the capacity of the power conversion apparatus, it is possible to realize the increase of the number of conversion circuit modules in which the problems due to the parallelization are solved.

Moreover, in the product for which the fuse is unnecessary, as illustrated in FIG. 8, if the conductive plates 5 and 6 in the first embodiment of the present invention are integrated with the multiphase conductive plates 5 and 6, it is possible to reduce the increase of the inductance which is made through the fuse, or an insulation process between the positive electrode terminal and the negative electrode terminal.

1. A power conversion apparatus that is configured by a plurality of conversion circuit modules which are connected to each other in parallel, comprising:
a first wiring that connects a positive electrode terminal of a first conversion circuit module among the conversion circuit modules, and a positive electrode side of a direct current wiring which supplies a direct current to the first conversion circuit module; and
a second wiring that connects a negative electrode terminal of a second conversion circuit module which is different from the first conversion circuit module among the conversion circuit modules, and a negative electrode side of a direct current wiring which supplies a direct current to the second conversion circuit module,
wherein when a direct current flows to the power conversion apparatus, the first wiring and the second wiring are arranged such that a magnetic coupling is generated between the first wiring and the second wiring.

2. The power conversion apparatus according to claim 1,
wherein each positive electrode terminal of the plurality of conversion circuit modules is connected to a first conductive plate,
each negative electrode terminal of the plurality of conversion circuit modules is connected to a second conductive plate, and
the first wiring and the second wiring are formed by respectively arranging current flow paths in the first conductive plate and the second conductive plate.

3. The power conversion apparatus according to claim 1,
wherein the first wiring and the second wiring are arranged at a position facing each other.

4. The power conversion apparatus according to claim 2,
wherein the current flow paths are formed by forming slits in the first conductive plate and the second conductive plate.

5. The power conversion apparatus according to claim 2,
wherein the first conductive plate and the second conductive plate form a stacked structure which interposes an insulating plate between the first conductive plate and the second conductive plate.

6. The power conversion apparatus according to claim 2,
wherein the number of the plurality of conversion circuit modules is three or more.
